(19) United States
(12) Patent Application Publication
(10) Pub. No.: US 2010/0014751 A1
(43) Pub. Date: Jan. 21, 2010

(54) IMAGE PROCESSING DEVICE, STORAGE MEDIUM, AND IMAGE PROCESSING METHOD

(75) Inventor: Emi KUROKAWA, Yokohama-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/504,133

(22) Filed: Jul. 16, 2009

(30) Foreign Application Priority Data
Jul. 18, 2008 (JP) 2008-187572

(51) Int. Cl. G06K 9/62; G06K 9/66

(52) U.S. Cl. 382/159; 382/190

(57) ABSTRACT

A face candidate of an object having movable ears is detected by a face candidate detection unit from an image of the object, and an ear of the object is detected by an attached site detection unit. The object is then detected from the image by a head portion determination unit in accordance with the detected face candidate and ear.

### TECHNICAL FIELD OF THE INVENTION

This invention relates to image processing.

### BACKGROUND OF THE INVENTION

A device described in JP2000-13066A is known as a conventional image processing device for extracting a face region of an object from an image. In JP2000-13066A, a face region is extracted from an image, the shape and the position of the face are detected from the face region, feature regions relating to the eyes, nose, mouth, and ears are extracted from the face region, and a direction of the face is detected by calculating feature points of the feature regions.

### SUMMARY OF THE INVENTION

An aspect of this invention is an image processing device for detecting an object from an image. The image processing device comprises a first detection unit that detects a specific site candidate of the object from the image, a second detection unit that detects an attached site that is joined to a specific site of the object from the image, and an object detection unit that detects the object from the image on the basis of a detection result of the first detection unit and a detection result of the second detection unit.

Another aspect of this invention is a computer-readable storage medium storing a program executed by a computer. The program comprises the step of detecting a specific site candidate of an object from an image, the step of detecting an attached site that is joined to a specific site of the object from the image, and the step of detecting the object from the image on the basis of information relating to the specific site candidate and information relating to the attached site.

A further aspect of this invention is an image processing method for detecting an object from an image. The method comprises detecting a specific site candidate of the object from the image, detecting an attached site that is joined to a specific site of the object from the image, and detecting the object from the image on the basis of information relating to the specific site candidate and information

### BRIEF DESCRIPTION OF THE DRAWINGS

FIG. 1 is a schematic block diagram showing an image processing device according to a first embodiment of this invention.

FIG. 2 is a view showing a face candidate region and so on according to the first embodiment of this invention.

FIG. 3 is a view showing a gradient direction and a gradient magnitude relating to an image.

FIG. 4 is a view showing a histogram of a case having the features shown in FIG. 3.

FIG. 5 is a view showing a histogram of a case in which two representative luminance gradient directions exist.

FIG. 6 is a flowchart for determining a head portion according to the first embodiment of this invention.

FIG. 7 is a flowchart illustrating a method of setting an attached site detection range according to the first embodiment of this invention.

FIG. 8 is a schematic block diagram showing an image processing device according to a second embodiment of this invention.

FIG. 9 is a view showing a first attached site region and so on according to the second embodiment of this invention.

FIG. 10 is a view illustrating a setting sequence of a second attached site detection range according to the second embodiment of this invention.

FIG. 11 is a view showing a face candidate region and so on according to the second embodiment of this invention.

FIG. 12 is a flowchart for determining a head portion according to the second embodiment of this invention.

FIG. 13 is a flowchart relating to attached site detection control according to the second embodiment of this invention.

### DESCRIPTION OF THE PREFERRED EMBODIMENTS

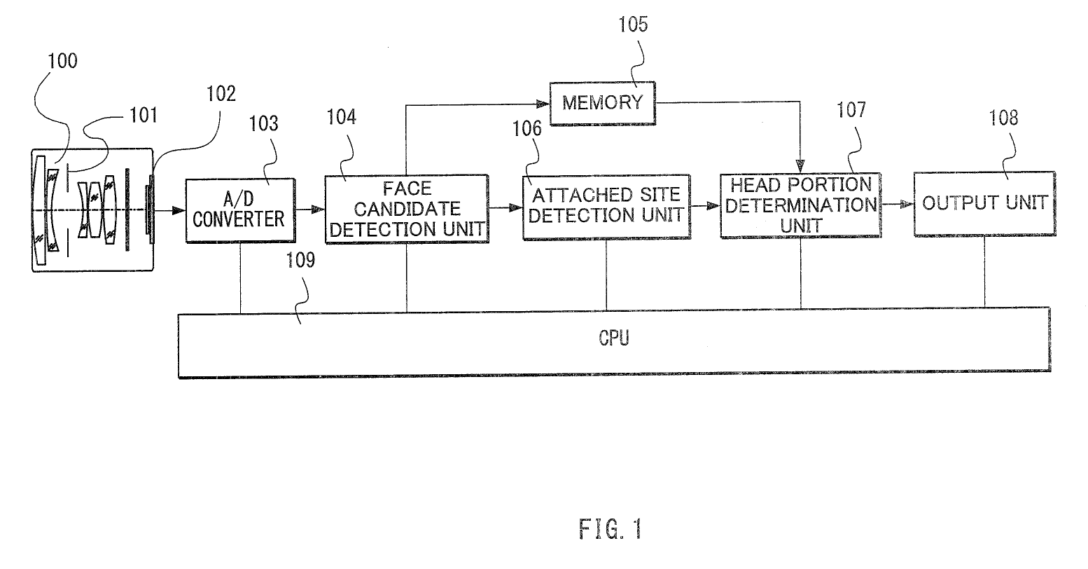

The constitution of a first embodiment of this invention will now be described using FIG. 1. FIG. 1 is a schematic diagram showing an image processing device according to this embodiment. In the following description, the term “object” refers to a pet such as a cat or a dog. Further, the term “face” denotes a central region of a head portion of the pet, which is constituted by eyes, nose, and mouth but does not include ears (in this specification, the face corresponds to a specific site, for example). The term “head portion” denotes the entirety of a part from the neck upward, and includes the face and attached site. Further, the term “attached site” denotes the movable ears of the pet. It should be noted that the object is not limited to a pet, and may be an animal such as a dog or a cat, or a character from a cartoon or an animation, for example. Furthermore, the attached site is not limited to ears, and includes any projecting part that projects from the face, such as a horn or a cock's comb.

The image processing device according to this embodiment comprises a lens system 100, a aperture 101, a CCD 102, an A/D converter 103, a face candidate detection unit (corresponding in this specification to a first detection unit, for example) 104, a memory 105, an attached site detection unit (corresponding in this specification to a second detection unit, for example) 106, a head portion determination unit (corresponding in this specification to an object detection unit, for example) 107, an output unit 108, and a CPU 109.

The lens system 100 is constituted by a plurality of lenses. The lens system 100 forms an image of an object in a predetermined position. The aperture 101l adjusts an amount of light reaching the CCD 102 per time unit. The CCD 102 converts an optical image formed via the lens system 100 and the aperture 101 into photoelectrons and outputs the converted optical image as an analog image signal. It should be noted that another image forming device, such as a CMOS, for example, may be used instead of the CCD 102. The A/D converter 103 converts the analog image signal output by the CCD 102 into a digital image signal.

The face candidate detection unit 104 sets a face candidate region including a face candidate (corresponding in this specification to a specific site candidate, for example) of the object from the image signal output by the A/D converter 103. The face candidate detection unit 104 detects the face candidate using the Viola-Jones method, for example. In the Viola-Jones method, a plurality of classifiers constructed by machine learning in advance are applied to an image. Thus, a face candidate can be detected from the image at high speed. The Viola-Jones method is described in “Rapid Object Detection Using a Boosted Cascade of Simple Features”, P. Viola and M. Jones in Proc. of CVPR, vol. 1, pp. 511-518, December, 2001, for example.

Alternatively, the face candidate detection unit 104 may detect the face candidate by a method employing a Gabor filter and graph matching. In a method employing a Gabor filter and graph matching, a feature amount is calculated by convoluting a Gabor wavelet and a proximal region to a face feature point. A face graph is extracted from the input image. A similarity in the feature amounts of a pre-recorded face graph and the face graph obtained from the input image is then detected. A method employing a Gabor filter and graph matching is described in “Face Recognition by Elastic Bunch Graph Matching”, Laurenz Wiskott, Jean-Marc Fellous, Norbert Kruger, and Christoph von der Malsburg, in Intelligent Biometric Techniques in Fingerprint and Face Recognition, eds. L. C. Jain et al., publ. CRC Provv, ISBN 0-8493-2055-0, Chapter 11, pp. 355-396, (1999), for example.

The memory 105 stores an image signal representing the face candidate region detected by the face candidate detection unit 104.

The attached site detection unit 106 sets a detection range for detecting an attached site joined to the face on the basis of position information and size information relating to the face candidate region detected by the face candidate detection unit 104. Further, the attached site detection unit 106 detects the attached site from the set detection range. The detection range set by the attached site detection unit 106 and the attached site will be described in detail below. In this embodiment, the attached site is an ear, and therefore the attached site exists in two locations. Hereafter, one of the attached sites will be referred to as a first attached site and an attached site that forms a pair with the first attached site will be referred to as a second attached site.

The head portion determination unit 107 determines whether or not the face candidate is a face. Further, the head portion determination unit 107 determines the head portion on the basis of the image signal representing the face candidate region stored in the memory 105 and image signals representing the first attached site and the second attached site detected by the attached site detection unit 106. Information relating to the determined head portion is output to the output unit 108.

The output unit 108 outputs the information relating to the head portion detected by the head portion determination unit 107. In an image processing device including a display, for example, the head portion of an image of the object displayed on the display is surrounded by a square frame.

The CPU 109 is connected to the A/D converter 103, the face candidate detection unit 104, the attached site detection unit 106, the head portion determination unit 107, and the output unit 108, and controls processing in the A/D converter 103 and the respective units.

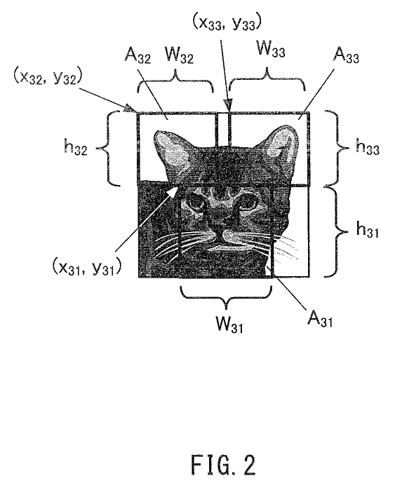

The detection range set by the attached site detection unit 106 will now be described in detail using FIG. 2. FIG. 2 is a view showing a face candidate region A₃₁ and attached site detection ranges A₃₂, A₃₃ on an object in an image. In FIG. 2, coordinates of an upper left apex of the face candidate region A₃₁ are set as (x₃₁, y₃₁), a width of the face candidate region A₃₁ set as W₃₁, and a height is set as h₃₁. It should be noted that in FIG. 2, the upper left apex of the image is set as an origin (not shown) such that a direction extending along an upper side of the image from the origin is set as an x axis forward direction and a direction extending along a left side of the image from the origin is set as a y axis forward direction.

To detect the first attached site, the attached site detection unit 106 calculates a detection range (corresponding in this specification to a first detection range, for example) A₃₂ assumed to include the first attached site in relation to the face candidate region A₃₁, which includes the face candidate detected by the face candidate detection unit 104, using the following Equations (1) to (3). The detection range A₃₂ is set as a first attached site detection range. In FIG. 2, coordinates of an upper left apex of the first attached site detection range A₃₂ are set as (x₃₂, y₃₂), a width of the first attached site detection range A₃₂ is set as W₃₂, and a height is set as h₃₂.

(x₃₂,y₃₂)=((x₃₁−w₃₁/2),(y₃₁−h₃₁)) Equation (1)

W₃₂=W₃₁ Equation (2)

h₃₂=h₃₁ Equation (3)

Further, to detect the second attached site, the attached site detection unit 106 calculates a detection range (corresponding in this specification to a second detection range, for example) A₃₃ assumed to include the second attached site in relation to the face candidate region A₃₁ using the following Equations (4) to (6). The detection range A₃₃ is set as a second attached site detection range. In FIG. 2, coordinates of an upper left apex of the second attached site detection range A₃₃ are set as (x₃₃, y₃₃), a width of the second attached site detection range A₃₃ is set as W₃₃, and a height is set as h₃₃.

(x_{33,}y₃₃)=((x₃₁+w₃₁/2),(y₃₁−h₃₁)) Equation (4)

w₃₃=w₃₁ Equation (5)

h₃₃=h₃₁ Equation (6)

It should be noted that the coordinate settings and so on of the face candidate region A₃₁, the first attached site detection range A₃₂, and the second attached site detection range A₃₃ are not limited to those described above. Further, the first attached site detection range A₃₂ and the second attached site detection range A₃₃ are not limited to the size described above and may be set at a minimum size for including the attached sites of all types of objects. In other words, the sizes of the first attached site detection range A₃₂ and the second attached site detection range A₃₃ are set in accordance with the object.

By setting the ranges for detecting the first attached site and the second attached site on the basis of the face candidate region A₃₁, a situation in which detection of the first attached site and the second attached site is performed in a region in which the attached sites joined to the face candidate do not exist can be prevented.

Next, the method by which the attached site detection unit 106 detects the attached site will be described in detail.

In this embodiment, the attached site detection unit 106 detects the attached site within the detection range using a feature extraction method employing SIFT (Scale-Invariant Feature Transform).

First, the attached site detection unit 106 calculates a size m (x, y) and a gradient direction θ (x, y) of a luminance gradient of an image L (x, y) of the first attached site detection range A₃₂ using the following Equations (7) and (8).

$$\begin{matrix}m ( x , y ) = \sqrt{{{f}_{x} ( x , y )}^{2} + {{f}_{y} ( x , y )}^{2}} & Equation ( 7 ) \\ θ ( x , y ) = {tan}^{- 1} \frac{{f}_{y} ( x , y )}{{f}_{x} ( x , y )} & Equation ( 8 )\end{matrix}$$

Here, when a luminance value on the coordinates (x, y) is set as L (x, y), fx (x, y) and fy (x, y) correspond to the following Equation (9).

fₓ(x,y)=L(x+1,y)−L(x−1,y)

f_{y}(x,y)=L(x,y+1)−L(x,y−1) Equation (9)

The direction of the luminance gradient is a direction in which the luminance varies, and the size of the luminance gradient is a value expressing the intensity of this variation. When the attached site and a background thereof take different luminance values, the size of the luminance gradient increases on the edge of the attached site and the direction of the luminance gradient corresponds to a normal direction of the edge of the attached site.

Next, the attached site detection unit 106 calculates a weighted luminance gradient size W (x, y) by multiplying the luminance gradient size m (x, y) by a Gaussian distribution G (x, y, σ) using the following Equation (10). The reference symbol σ indicates a standard deviation.

w(x,y)=G(x,y,σ)·m(x,y) Equation (10)

The attached site detection unit 106 then calculates a histogram hθ′ quantizing all directions into 36 directions using the weighted luminance gradient size W (x, y) relative to each gradient direction (θ=0 to 360°), a delta function 6, and the gradient direction θ (x, y) in accordance with the following Equation (11). The reference symbol θ′ indicates a direction obtained by quantizing the gradient direction θ (x, y). The 36 directions are set by dividing 360° by ten.

$$h {θ}^{′} = {\sum }_{x} {\sum }_{y} W ( x , y ) \cdot δ [ {θ}^{′} , θ ( x , y ) ] \qquad Equation ( 11 )$$

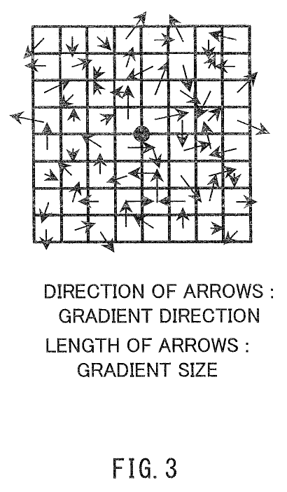

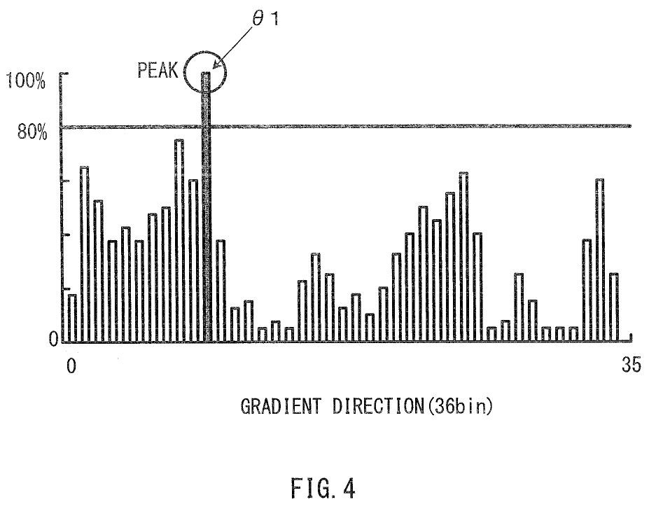

When the first attached site is absent from the image L (x, y) of the first attached site detection range A₃₂, the gradient direction θ (x, y) and gradient size m (x, y) are as shown in FIG. 3, for example. FIG. 4 shows a histogram in this case. Assuming that a maximum value of the histogram is 100%, the position of a maximum peak in locations where the histogram is at 80% or more is set as a gradient direction (first gradient direction hereafter) θ1 having a first representative luminance. When the first attached site is absent, the histogram does not reach or exceed 80% in locations other than the first gradient direction.

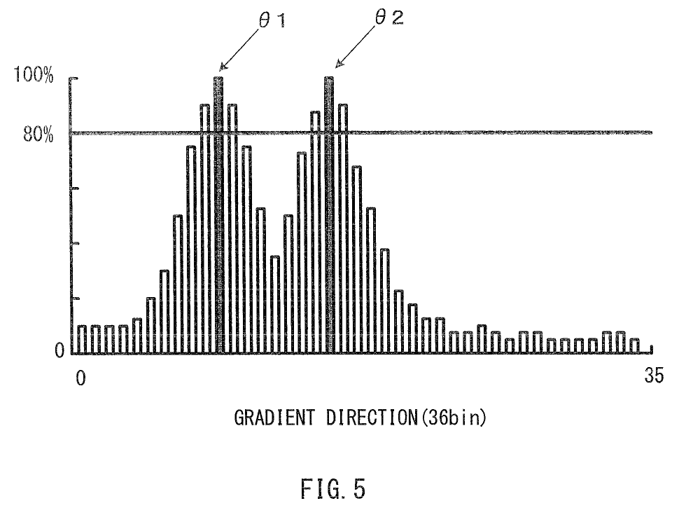

When the first attached site is present in the image L (x, y) of the first attached site detection range A₃₂, on the other hand, the image L (x, y) includes a gradient direction θ (x, y) and a gradient size m (x, y) exhibiting certain characteristics, similarly to FIG. 3. FIG. 5 shows a histogram in this case. As shown in FIG. 5, in the histogram of the image L (x, y) including the first attached site, another peak is obtained in addition to the first gradient direction θ1. The other peak is set as a gradient direction (second gradient direction hereafter) θ2 having a second representative luminance.

From the histogram calculated using Equation (11), the attached site detection unit 106 calculates the first gradient direction θ1 and the second gradient direction θ2. The attached site detection unit 106 then detects the first attached site on the basis of the first gradient direction θ1 and the second gradient direction θ2. In this embodiment, the attached site detection unit 106 determines that the first attached site is present when an angle between the first gradient direction θ1 and the second gradient direction θ2 is within a predetermined angle. The predetermined angle is set at 20° to 80°, for example. However, the predetermined angle is not limited to this range, and may be set according to the characteristics of the first attached site.

The attached site detection unit 106 performs similar calculations in relation to the second attached site detection range A₃₃ to detect the second attached site.

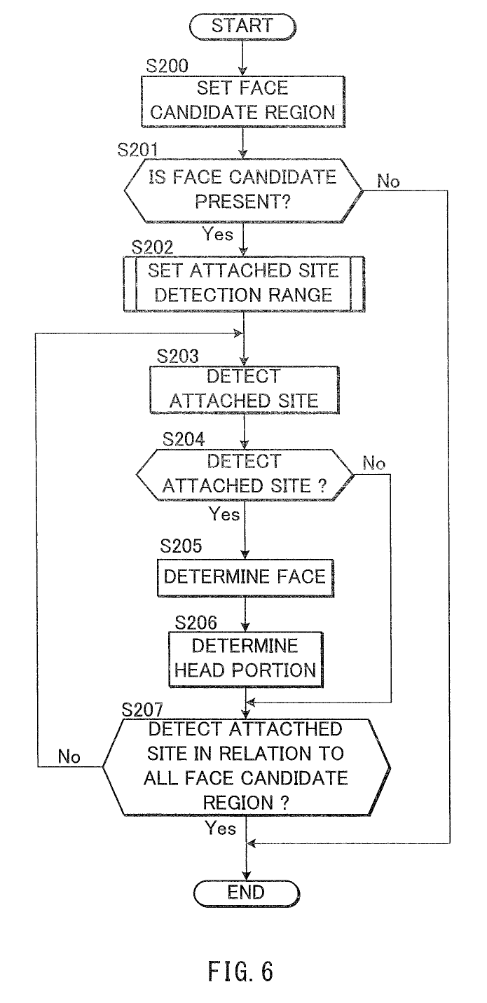

Next, a method of determining the head portion according to this embodiment will be described using a flowchart shown in FIG. 6.

In a step S200, a face candidate is detected using facial features including eyes, nose, and mouth by employing the Viola-Jones method, and the face candidate region A₃₁ including the face candidate is set. When the image includes a plurality of objects, the face candidate region A₃₁ is set in relation to each object.

In a step S201, a determination is made as to whether or not the face candidate is present in the image. When the face candidate is present, the routine advances to a step S202, and when the face candidate is absent, the control is terminated.

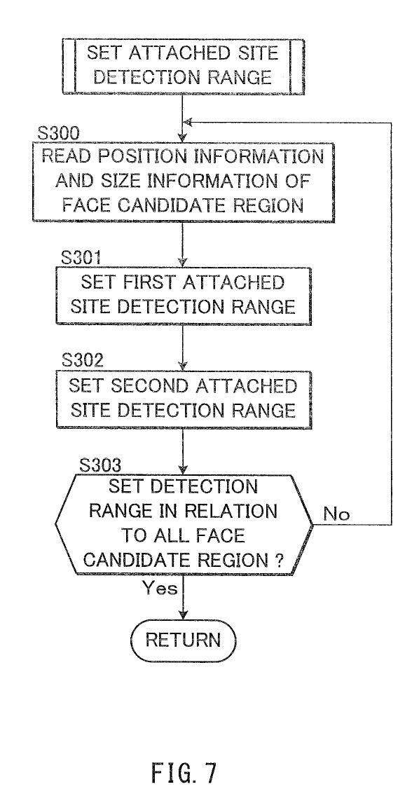

In the step S202, an attached site detection range is set. A method of setting the attached site detection range will now be described using a flowchart shown in FIG. 7.

In a step S300, the position information (x₃₁, y₃₁) and size information (W₃₁, h₃₁) of the face candidate region A₃₁ are read.

In a step S301 (corresponding in this specification to a first detection range determination unit, for example), the first attached site detection range A₃₂ relating to the face candidate region A₃₁ is set on the basis of Equations (1) to (3).

In a step S302 (corresponding in this specification to a second detection range determination unit, for example), the second attached site detection range A₃₃ relating to the face candidate region A₃₁ is set on the basis of Equations (4) to (6).

In a step S303, a determination is made as to whether or not the first attached site detection range A₃₂ and the second attached site detection range A₃₃ have been set in relation to all of the face candidate regions A₃₁. When the first attached site detection range A₃₂ and the second attached site detection range A₃₃ have been set in relation to all of the face candidate regions A₃₁, the control is terminated. When the first attached site detection range A₃₂ and the second attached site detection range A₃₃ have not been set in relation to all of the face candidate regions A₃₁, the routine returns to the step S300, where the control described above is repeated.

As a result of the control described above, the first attached site detection range A₃₂ and the second attached site detection range A₃₃ are set in relation to the face candidate region A₃₁.

Returning to FIG. 6, in a step S203, the first attached site is detected from the first attached site detection range A₃₂ set in relation to the face candidate region A₃₁. Further, the second attached site is detected from the second attached site detection range A₃₃ set in relation to the face candidate region A₃₁. In this embodiment, the first attached site is detected by applying a feature extraction method employing SIFT to the first attached site detection range A₃₂. Further, the second attached site is detected by applying a feature extraction method employing SIFT to the second attached site detection range A₃₃.

In a step S204, a determination is made as to whether or not the first attached site has been detected from the first attached site detection range A₃₂ and the second attached site has been detected from the second attached site detection range A₃₃. When the first attached site and the second attached site have been detected, the routine advances to a step S205, and when either the first attached site or the second attached site has not been detected, the routine advances to a step S207.

When the first attached site and the second attached site have been detected in relation to the face candidate region A₃₁, the face candidate of the face candidate region A₃₁ is determined to be a face in the step S205 (corresponding in this specification to a specific site determination unit, for example). By determining only a face candidate region A₃₁ in which both the first attached site and the second attached site have been detected to be a face, face detection can be performed accurately.

In a step S206, the head portion is determined by the face, the first attached site, and the second attached site. Thus, the object is determined to be present in the image.

In this embodiment, the head portion can be detected accurately regardless of movement of the attached site by setting the first attached site detection range A₃₂ and the second attached site detection range A₃₃ in relation to the face candidate region A₃₁ and then determining whether or not the first attached site or the second attached site is present therein.

In the step S207, a determination is made as to whether or not detection of the first attached site and the second attached site has been performed on all of the set face candidate regions A₃₁. When detection of the first attached site and the second attached site has been performed on all of the face candidate regions A₃₁, the control is terminated. When detection of the first attached site and the second attached site has not been performed on all of the face candidate regions A₃₁, the routine returns to the step S203, where the control described above is repeated in relation to face candidate regions A₃₁ in which the first attached site and the second attached site have not been detected.

Effects of the first embodiment of this invention will now be described.

In this embodiment, a face candidate of the object is detected from the image, the first attached site detection range A₃₂ and the second attached site detection range A₃₃ are set on the basis of information relating to the face candidate region A₃₁ including the face candidate, and then the first attached site and the second attached site are detected. By detecting the face candidate and the attached sites of the object separately, the head portion of the object in the image can be detected accurately. Therefore, even when the object is a cat having movable ears, for example, the head portion of the object can be detected accurately. As a result, an AF during image capture, an image search for searching an object such as a cat or a dog from a web image, for example, can be performed quickly and accurately.

Further, when the first attached site and the second attached site are detected in relation to the face candidate, the face candidate is determined to be a face. Hence, the face of the object can be detected accurately, enabling accurate detection of the head portion of the object.

The first attached site detection range A₃₂ and the second attached site detection range A₃₃ assumed to include the first attached site and the second attached site are set on the basis of the position information and the size information of the face candidate region A₃₁. A determination is then made as to whether or not the first attached site or the second attached site is present therein. Since attached site detection is not performed on the face candidate region A₃₁ in far removed locations, the time required to detect the attached site can be reduced and the head portion of the object can be detected accurately.

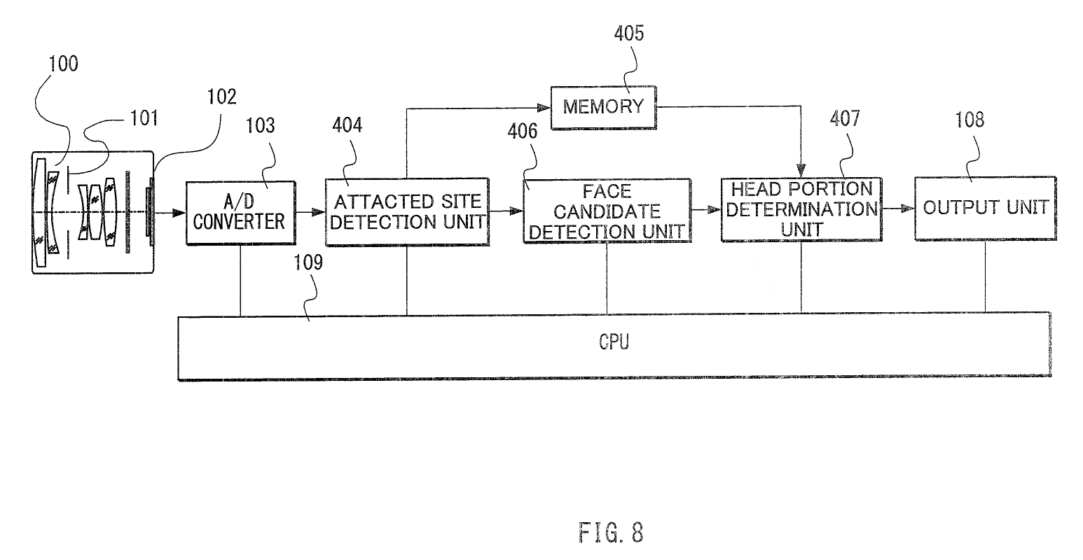

Next, a second embodiment of this invention will be described using FIG. 8. Identical constitutions to the first embodiment have been allocated identical reference numerals to those of FIG. 1, and description thereof has been omitted. In this embodiment, an attached site detection unit 404, a memory 405, a face candidate detection unit 406, and a head portion determination unit 407 differ from their counterparts in the first embodiment.

The attached site detection unit 404 sets a region including a first attached site candidate (to be referred to hereafter as a “first attached site region” (corresponding in this specification to a first region, for example)) on the basis of the image signal output from the A/D converter 103. Further, the attached site detection unit 404 sets a search range for the second attached site (to be referred to hereafter as a “second attached site search range (corresponding in this specification to a second region, for example)), and sets a range for detecting the second attached site (to be referred to hereafter as a second attached site detection range) within the second attached site search range. The second attached site is then detected from the second attached site detection range. The first attached site region, the second attached site search range, and the second attached site detection range will be described in detail below.

The memory 405 stores an image signal representing the first attached site and the second attached site detected by the attached site detection unit 404.

The face candidate detection unit 406 sets a face candidate detection range for detecting a face candidate (corresponding in this specification to a third detection range, for example) on the basis of the position information and the size information of the first attached site and the second attached site detected by the attached site detection unit 404. The face candidate detection range will be described in detail below. Further, the face candidate detection unit 406 detects a face candidate from the face candidate detection range.

The head portion determination unit 407 determines the head portion on the basis of an image signal representing the first attached site and the second attached site stored in the memory 405 and an image signal representing the face candidate detected by the face candidate detection unit 406. Information relating to the determined head portion is output to the output unit 108.

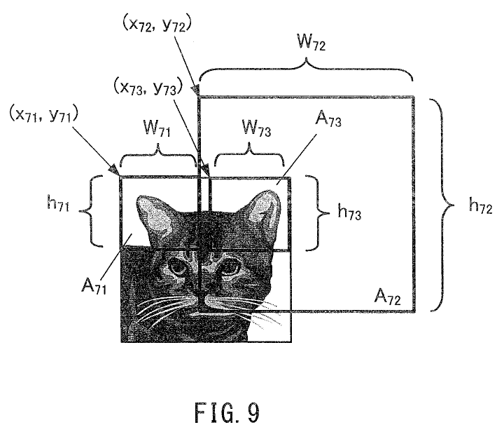

The first attached site region, the second attached site search range, and the second attached site detection range set in the attached site detection unit 404 will now be described using FIG. 9. FIG. 9 is a view showing the first attached site region, the second attached site search range, and the second attached site detection range. In FIG. 9, coordinates of an upper left apex of a first attached site region A₇₁ are set as (x₇₁, y₇₁), a width of the first attached site region A₇₁ is set as W₇₁, and a height is set as h₇₁.

The attached site detection unit 404 detects a corner using a feature extraction method employing SIFT, and sets a first attached site region A₇₁ including a first attached site candidate. In the feature extraction method employing SIFT, a window size describing a feature amount is determined in accordance with a scale size of a feature point obtained during detection of the feature point. A region of a predetermined size determined through this process is set as the first attached site region A₇₁.

After setting the first attached site region A₇₁, the attached site detection unit 404 calculates and sets a second attached site search range A₇₂ in the vicinity of the first attached site region A₇₁ using the following Equations (12) to (14). In FIG. 9, coordinates of an upper left apex of the second attached site search range A₇₂ are set as (x₇₂, y₇₂), a width of the second attached site search range A₇₂ is set as W₇₂, and a height is set as h₇₂.

(x₇₂,y₇₂)=((x₇₁+W₇₁),(y₇₁−h₇₁)) Equation (12)

W₇₂=3W₇₁ Equation (13)

h₇₂=3h₇₁ Equation (14)

The second attached site search range A₇₂ has a greater size than the first attached site region A₇₁ and is set such that an attached site relating to any type of object can be detected. Further, the second attached site search range A₇₂ is provided in the vicinity of the first attached site region A₇₁. By providing the second attached site search range A₇₂ in the vicinity of the first attached site region A₇₁, a situation in which an attached site that is far removed from the first attached site and does not form a pair with the first attached site is detected can be prevented. Accordingly, the second attached site that forms a pair with the first attached site can be detected accurately. It should be noted that in this embodiment, the second attached site search range A₇₂ is adjacent to the first attached site region A₇₁, but the second attached site search range A₇₂ does not have to be provided adjacent to the first attached site region A₇₁. Further, a part of the second attached site search range A₇₂ may be provided so as to overlap the first attached site region A₇₁. Moreover, the size of the second attached site search range A₇₂ is not limited to the size described above, and may be set at any size as long as the second attached site that forms a pair with the first attached site can be detected accurately.

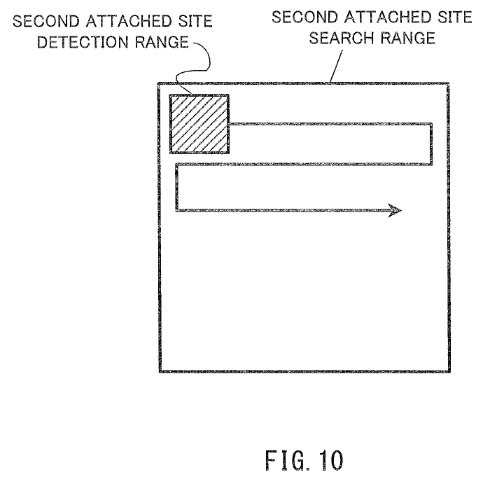

After setting the second attached site search range A₇₂, the attached site detection unit 404 sets a second attached site detection range A₇₃ within the second attached site search range A₇₂ such that the following Equations (15) and (16) are satisfied. In FIG. 9, coordinates of an upper left apex of the second attached site detection range A₇₃ are set as (x₇₃, y₇₃), a width of the second attached site detection range A₇₃ is set as W₇₃, and a height is set as h₇₃. As shown in FIG. 10, for example, the second attached site detection range A₇₃ is set in sequence from the upper left of the second attached site search range A₇₂.

$$\begin{matrix}0.8 \leq \frac{{W}_{73}}{{W}_{71}} \leq 1.2 & Equation ( 15 ) \\ 0.8 \leq \frac{{h}_{73}}{{h}_{71}} \leq 1.2 & Equation ( 16 )\end{matrix}$$

By setting the second attached site detection range A₇₃ to be related to the first attached site region A₇₁ as described above, it is possible to detect only a second attached site that has a substantially identical size to the first attached site. As a result, the second attached site that forms a pair with the first attached site can be detected accurately.

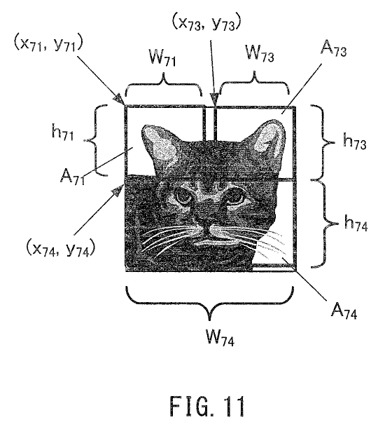

The face candidate region in the face candidate detection unit 406 will now be described using FIG. 11. FIG. 11 is a view showing the first attached site region A₇₁, the second attached site detection range A₇₃, and a face candidate region A₇₄. In FIG. 11, coordinates of an upper left apex of the face candidate region A₇₄ are set as (x₇₄, y₇₄), a width of the face candidate region A₇₄ is set as W₇₄, and a height is set as h₇₄.

The face candidate detection unit 406 sets the face candidate region A₇₄ in a peripheral region of the first attached site region A₇₁ or the second attached site search range A₇₃ on the basis of following Equations (17) to (19).

(x₇₄,y₇₄)=(x₇₄,(y₇₁+h₇₁)) Equation (17)

W₇₄=x₇₃+W₇₃−x₇₁ Equation (18)

h₇₄=W₇₄ Equation (19)

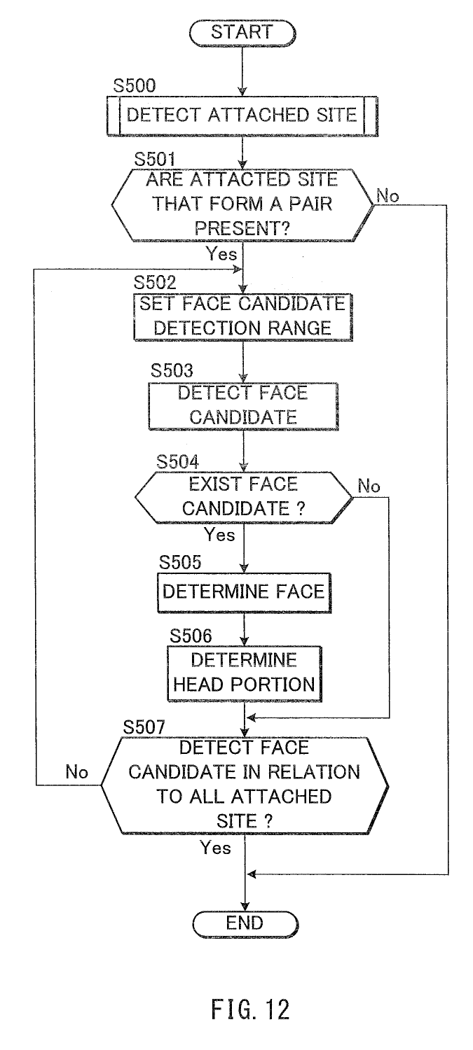

Next, a method of determining the head portion according to this embodiment will be described using a flowchart shown in FIG. 12.

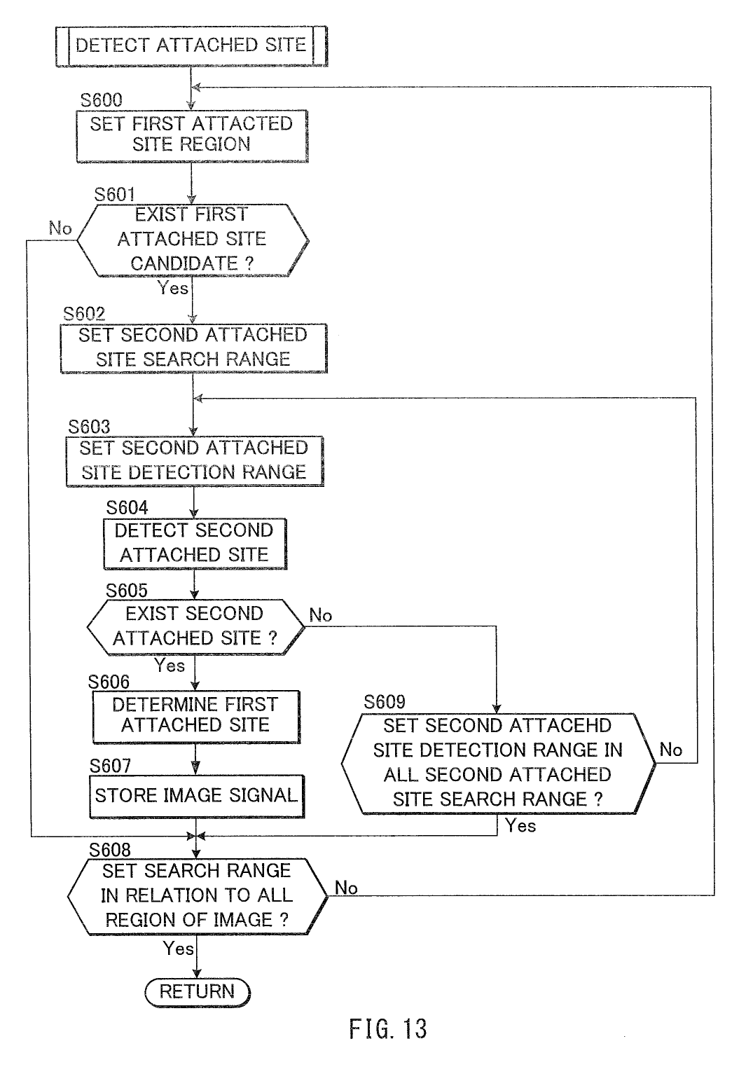

In a step S500, the first attached site and the second attached site are detected. A method of detecting the attached sites will now be described using a flowchart shown in FIG. 13.

In a step S600 (corresponding in this specification to a first region setting unit, for example), the first attached site region A₇₁ including a first attached site candidate is set in a search range using a feature extraction method employing SIFT, similarly to the first embodiment. The search range is a region having a preset size that is larger than a maximum size of the first attached site region A₇₁ relating to all types of objects.

In a step S601, a determination is made as to whether or not the first attached site candidate exists in the search range and the first attached site region A₇₁ has been set. When the first attached site region A₇₁ has been set in the search range, the routine advances to a step S602. When the first attached site region A₇₁ has not been set in the search range, the routine advances to a step S608.

In the step S602 (corresponding in this specification to a second region setting unit, for example), the second attached site search range A₇₂ is set on the basis of Equations (12) to (14).

In a step S603, the second attached site detection range A₇₃ is set in the second attached site search range A₇₂ on the basis of Equations (15) and (16).

In a step S604, the second attached site is detected from the second attached site detection range A₇₃. In this embodiment, the second attached site is detected from the second attached site detection range A₇₃ using a feature extraction method employing SIFT, similarly to the first embodiment.

In a step S605, a determination is made as to whether or not the second attached site exists in the second attached site detection range A₇₃. When the second attached site exists in the second attached site detection range A₇₃, the routine advances to a step S606. When the second attached site does not exist in the second attached site detection range A₇₃, the routine advances to a step S609.

In the step S606, the second attached site that forms a pair with the first attached site candidate has been detected, and therefore the first attached site candidate is determined to be the first attached site.

In a step S607, an image signal representing the first attached site and the second attached site is stored in the memory 405.

In the step S608, a determination is made as to whether or not search ranges have been set in relation to all regions of the image. When search ranges have been set in relation to all regions of the image, the control is terminated. When search ranges have not been set in relation to all regions of the image, a new search range is set and the routine returns to the step S600, where the control described above is repeated.

When it is determined in the step S605 that the second attached site does not exist in the second attached site detection range A₇₃, on the other hand, a determination is made in the step S609 as to whether or not the second attached site detection range A₇₃ has been set in all regions of the second attached site search range A₇₂. When the second attached site detection range A₇₃ has been set in all second attached site search ranges A₇₂, the routine advances to the step S608. When the second attached site detection range A₇₃ has not been set in a region of the second attached site search range A₇₂, the routine returns to the step S603, in which a new second attached site detection range A₇₃ is set and the control described above is repeated.

Through the control described above, the first attached site and the second attached site are detected.

Returning to FIG. 12, in a step S501, a determination is made as to whether or not the first attached site and the second attached site that forms a pair with the first attached site are present. When the first attached site and the second attached site that forms a pair with the first attached site are present, the routine advances to a step S502, and when either the first attached site or the second attached site that forms a pair with the first attached site is absent, the control is terminated.

In the step S502, when the first attached site and the second attached site that forms a pair with the first attached site are present, a face candidate detection range is set in a peripheral region of the first attached site or the second attached site in accordance with the position information and the size information of the first attached site and the second attached site on the basis of Equations (17) to (19).

In a step S503, face candidate detection is performed within the face candidate detection range. The face candidate detection is performed using the Viola-Jones method, for example.

In a step S504, a determination is made as to whether or not a face candidate exists within the face candidate detection range. When a face candidate region exists within the face candidate detection range, the routine advances to a step S505. When a face candidate does not exist within the face candidate detection range, the routine advances to a step S507.

In the step S505, after detecting the first attached site, the second attached site that forms a pair with the first attached site, and the face candidate, the face candidate is determined to be the face of the object.

In a step S506, the head portion of the object is determined from the first attached site, the second attached site, and the face of the object.

In the step S507, a determination is made as to whether or not the face candidate detection has been performed in relation to all first attached sites and the second attached sites. When the face candidate detection has been performed in relation to all first attached sites and second attached sites, the control is terminated. When the face candidate detection has not been performed in relation to a first attached site or a second attached site, the routine returns to the step S502, in which the control described above is repeated.

It should be noted that the following method may be used as the method for setting the first attached site region A₇₁.

First, a corner location is detected from the search range. The corner is detected using a feature extraction method employing SIFT. A histogram is then created, whereupon the first gradient direction θ1 and the second gradient direction θ2 are calculated and an angle between the first gradient direction θ1 and the second gradient direction θ2 is calculated. When the angle is between 20° and 80°, for example, it can be determined that the detected corner is a tip end of an ear serving as the first attached site.

Next, a well-known edge detection method in which a luminance value is subjected to primary differentiation and a location exhibiting a large rate of change is detected as an edge is applied from the tip end of the first attached site. As a result, the edge of the first attached site is detected.

After detecting the tip end of the first attached site and the edge of the first attached site, a different corner is detected along the edge of the first attached site extending from the tip end of the first attached site using a feature extraction method employing SIFT, for example. In so doing, a base end of the first attached site can be detected. The Harris method, the SUSAN method, and so on may be used as the corner detection method.

After detecting the tip end of the first attached site and the base end of the first attached site, a region including these ends is set as the first attached site region A₇₁. Thus, the size of the first attached site can be calculated accurately.

Effects of the second embodiment of this invention will now be described.

After setting the first attached site region A₇₁ including the first attached site, the second attached site search range A₇₂ having a greater size than the first attached site region A₇₁ is set in the vicinity of the first attached site region A₇₁. The second attached site is then detected in the second attached site search range A₇₂. By limiting the size of the second attached site search range A₇₂, for example setting the size of the second attached site search range A₇₂ such that a second attached site relating to all types of object fits therein, a situation in which an attached site that does not form a pair with the first attached site is detected can be prevented. Therefore, the second attached site that forms a pair with the first attached site can be detected accurately. Furthermore, the processing time required to detect the second attached site that forms a pair with the first attached site can be shortened, enabling a reduction in the time required for face detection processing. Moreover, the head portion of the object can be detected accurately.

Further, the face candidate region A₇₄ is set in accordance with the position information and the size of the first attached site and the second attached site, whereupon the face candidate is detected in the face candidate region A₇₄. Hence, a situation in which a face candidate that is not joined to the first attached site and the second attached site is detected can be prevented, enabling accurate detection of the head portion of the object.

It should be noted that in the embodiments described above, the face is determined when the face candidate, the first attached site, and the second attached site are detected, but the face may be determined when one of the first attached site and the second attached site is detected. In this case, a reliability value or the like of the face in the face candidate region may be calculated such that when the reliability value of the face is high and either the first attached site or the second attached site has been detected, the face, and accordingly the head portion of the object, is determined.

Further, the image processing device described above may be installed in an electronic machine that is dependent on a current or an electromagnetic field to operate correctly, such as a digital camera, a digital video camera, or an electronic endoscope.

Furthermore, in the embodiments described above, it is assumed that the processing performed by the image processing device is hardware processing, but there is no need to limit the invention to this constitution, and the processing may be performed using separate software, for example.

In this case, the image processing device comprises main storage devices such as a CPU and a RAM, and a computer-readable storage medium storing a program for realizing all or a part of the processing described above. Here, this program will be known as an image processing program. By having the CPU read the image processing program stored on the storage medium so as to execute information processing/calculation processing, similar processing to that of the image processing device described above is realized.

Here, the computer-readable storage medium is a magnetic disk, a magneto-optical disk, a CD-ROM, a DVD-ROM, a semiconductor memory, or similar. Alternatively, the image processing program may be distributed to a computer via a communication line such that the computer, having received the distributed program, executes the image processing program.

This application claims priority based on Japanese Patent Application 2008-187572, filed with the Japan Patent Office on Jul. 18, 2008, the entire contents of which are incorporated into this specification by reference.

What is claimed is:

1. An image processing device for detecting an object from an image, comprising:
a first detection unit for detecting a specific site candidate of the object from the image;
a second detection unit for detecting an attached site that is joined to a specific site of the object from the image; and
an object detection unit for detecting the object from the image on the basis of detection result of the first detection unit and a detection result of the second detection unit.

2. The image processing device as defined in claim 1, wherein the second detection unit detects a first attached site that is joined to the specific site and a second attached site that is joined to the specific site and forms a pair with the first attached site on the basis of the detection result of the first detection unit.

3. The image processing device as defined in claim 2, further comprising a specific site determination unit for determining the specific site candidate to be the specific site when the first attached site and the second attached site are detected in relation to the specific site candidate
wherein the object detection unit detects the object from the image on the basis of the specific site determined by the specific site determination unit and the attached site.

4. The image processing device as defined in claim 2, wherein the second detection unit comprises:
a first detection range determination unit for setting a first detection range for detecting the first attached site on the basis of position information and size information relating to the specific site candidate detected by the first detection unit; and
a second detection range determination unit for setting a second detection range for detecting the second attached site on the basis of the position information and the size information relating to the specific site candidate detected by the first detection unit, wherein
the second detection unit detects the first attached site from the first detection range and detects the second attached site from the second detection range.

5. The image processing device as defined in claim 1 wherein the first detection unit detects the specific site candidate on the basis of the detection result of the second detection unit.

6. The image processing device as defined in claim 5, wherein the first detection unit sets a third detection range for detecting the specific site candidate on the basis of position information and size information relating to the attached site detected by the second detection unit, and detects the specific site candidate from the third detection range.

7. The image processing device as defined in claim 5, wherein the second detection unit comprises:
a first region setting unit for setting a first region on the basis of information relating to a first attached site joined to the specific site; and
a second region setting unit for setting a second region having a larger size than the first region in a vicinity of the first region on the basis of information relating to the object, wherein
the second detection unit detects a second attached site that is joined to the specific site and forms a pair with the first attached site from the second region.

8. The image processing device as defined in claim 1, wherein the attached site is capable of movement.

9. The image processing device as defined in claim 1, wherein the attached site is a projecting portion that projects from the specific site.

10. The image processing device as defined in claim 1, wherein the specific site is a face of an animal, and the attached site is an ear of the animal.

11. The image processing device as defined in claim 1, wherein the first detection unit detects the specific site candidate from a plurality of classifiers constructed by machine learning.

12. The image processing device as defined in claim 1, wherein the first detection unit detects the specific site candidate using a Gabor filter and graph matching.

13. An electronic machine comprising the image processing device as defined in claim 1.

14. A computer-readable storage medium storing a program executed by a computer, wherein the program comprises the steps of:
detecting a specific site candidate of an object from an image;
detecting an attached site that is joined to a specific site of the object from the image; and
detecting the object from the image on the basis of the detected specific site candidate and the detected attached site.

15. An image processing method for detecting an object from an image, comprising:
detecting a specific site candidate of the object from the image;
detecting an attached site that is joined to a specific site of the object from the image; and
detecting the object from the image on the basis of the detected specific site candidate and the detected attached site.
